(19) United States
(12) Patent Application Publication
(10) Pub. No.: US 2006/0059989 A1
(43) Pub. Date: Mar. 23, 2006

(54) Acceleration sensor for exercise apparatuses

(76) Inventors: Leao Wang, Taiping (TW); Peter Wu, Taiping (TW)

Correspondence Address: KUO-HSIUNG CHIU, 13F., NO.23, JIUN-HO STREET, PEITUN DISTRICT, TAICHUNG, 406, TW

(21) Appl. No.: 10/946,090

(22) Filed: Sep. 22, 2004

(51) Int. Cl. G01P 15/00

(52) U.S. Cl. 73/514.16

(57) ABSTRACT

An acceleration sensor for exercise apparatuses having a signal producer, a signal amplifying and transmitting apparatus and a microprocessor. The signal producer consists of a sensing coil and a permanent magnet. The permanent magnet is axially movable within the sensing coil without contact therewith. Exposure of the permanent magnet to a certain force results in a necessary slide movement. In this way, corresponding signals of different current values are created in accordance with the sliding speed of the permanent magnet and received by the sensing coil. The signal amplifying and transmitting apparatus is responsible for receiving and amplifying the current values sensed by the sensing coil, and the amplified current values are transmitted to the microprocessor. The microprocessor includes built-in programs to process the signals of the amplified current values for determining the acceleration of the object to be measured.

### BACKGROUND OF THE INVENTION

1. Fields of the Invention

The invention relates to an acceleration sensor for exercise apparatuses, and more particularly, to an apparatus that employs a permanent magnet which creates corresponding current values when forced to move in axial direction relative to a sensing coil. By use of the sensing coil, a signal amplifying and transmitting apparatus and a microprocessor, the acceleration of the object to be measured can be exactly detected.

2. Description of the Related Art

As shown in FIG. 2, a constant current is applied by use of an inductance meter to a sensing coil 11 for producing an electric field of certain frequency. Moreover, a magnetic bar 12 is employed to axially move within the sensing coil 11 for creating the relative position frequency difference with which the displacement of the object to be measured can be detected.

In light of the electronic theory, the aforementioned displacement detection technique belongs to an active sensing loop. That is, the sensor has to apply a constant current to the sensing coil 11 which is then made to be a signal producer. Displacement of the magnetic bar 12 relative to the sensing coil 11 enables interruption to the electric field. In this way, the position frequency difference will be created. However, the detection could fail due to unstable power supply or power failure.

Moreover, the detection of the acceleration of the object to be measured requires a parameter of time that is considered to be a factor affecting the economical efficiency.

### SUMMARY OF THE INVENTION

It is a primary object of the invention to provide an acceleration sensor for exercise apparatuses that employs a permanent magnet which creates corresponding current values when forced to move in axial direction relative to a sensing coil. By use of the sensing coil, a signal amplifying and transmitting apparatus and a microprocessor, the acceleration of the object to be measured can be exactly detected.

Evidently, the invention also employs the above-mentioned basic electronics. However, the acceleration of the object to be measured is detected by an “inactive sensing loop”. That is, the application of a constant current to the sensing coil is no more necessary.

### BRIEF DESCRIPTION OF THE DRAWINGS

The accomplishment of this and other objects of the invention will become apparent from the following description and its accompanying drawings of which:

FIG. 1 is a schematic drawing of a preferred embodiment of an acceleration sensor for exercise apparatuses in accordance with the invention; and

FIG. 2 is a schematic drawing of a conventional acceleration sensor.

### DETAILED DESCRIPTION OF THE PREFERRED EMBODIMENT

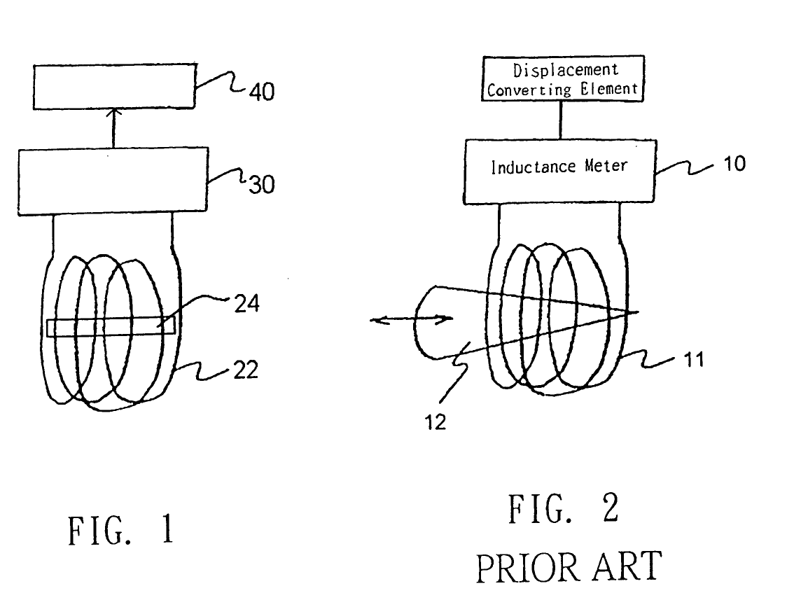

Referring to FIG. 1, an acceleration sensor for exercise apparatuses in accordance with the invention includes a signal producer 20, a signal amplifying and transmitting apparatus 30 and a microprocessor 40.

The signal producer 20 consists of a sensing coil 22 and a permanent magnet 24. The permanent magnet 24 is axially movable within the sensing coil 22 without contact therewith. Exposure of the permanent magnet 24 to a certain force results in a necessary slide movement. In this way, corresponding signals of different current values are created in accordance with the sliding speed of the permanent magnet 24 and received by the sensing coil 22.

The signal amplifying and transmitting apparatus 30 is responsible for receiving and amplifying the current values sensed by the sensing coil 22, and the amplified current values are transmitted to the microprocessor 40.

The microprocessor 40 includes built-in programs to process the signals of the amplified current values for determining the acceleration of the object to be measured.

The signal amplifying and transmitting apparatus 30 may employ wired or wireless transmission technique to transmit the signals of the current values to the microprocessor 40 for further processing. However, this belongs to prior art so that no further descriptions thereto are given hereinafter.

As mentioned, the exposure of the permanent magnet 24 creates a sliding displacement. The faster the permanent magnet 24 moves, the greater the produced current values will be. For the opposite case, the current values will be smaller. By use of data of the current values, the built-in programs of the microprocessor 40 will rapidly determine the corresponding acceleration, thereby resulting in excellent reaction efficiency. However, the computer program is not the object of the invention so that no further descriptions thereto are given hereinafter.

In respect of the application scopes and the expected effects of the invention, we will beg you to refer to the application Ser. Nos. 10/315,257 and 10/687,020. It's apparent from these two applications that the exercise device includes a punched body whose position is adjustable to the position boxing gloves and shoes. The acceleration sensor in accordance with the invention is installed in the boxing gloves and shoes while signal receivers of the control unit can receive the current value signals. Therefore, the position and the acceleration of the boxing gloves and shoes can be determined by the microprocessor of the control unit so that the punched body can be forced to escape to an optimal position. Accordingly, the reaction ability of the boxing trainer can be considerably improved by the acceleration sensor of the invention. In this way, interactive and simulative effects can be optimally achieved.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claim.

What is claimed is:

1. An acceleration sensor for exercise apparatuses comprising:
a) a signal producer having a sensing coil and a permanent magnet, the permanent magnet being axially movable within the sensing coil without contact therewith wherein exposure of the permanent magnet to a certain force results in a necessary slide movement so that corresponding signals of different current values are created in accordance with the sliding speed of the permanent magnet and received by the sensing coil;
b) a signal amplifying and transmitting apparatus responsible for receiving and amplifying the current values sensed by the sensing coil, the amplified current values being then transmitted to a microprocessor; and
c) a microprocessor having built-in programs to process the signals of the amplified current values for determining the acceleration of the object to be measured.
